(19) United States
(12) Patent Application Publication
(10) Pub. No.: US 2022/0374711 A1
(43) Pub. Date: Nov. 24, 2022

(54) Method for Determining an Inadmissible Deviation of the System Behavior of a Technical Device from a Standard Value Range

(71) Applicant: Robert Bosch GmbH, Stuttgart (DE)

(72) Inventor: Achim Romer, Weinsberg (DE)

(21) Appl. No.: 17/755,696

(22) PCT Filed: Nov. 5, 2020
(86) PCT No.: PCT/EP2020/081029

§ 371 Date: May 5, 2022

(30) Foreign Application Priority Data
Nov. 6, 2019 (DE) 10 2019 217 071.4

(51) Int. Cl. G06N 3/08

(52) U.S. Cl. CPC G06N 3/08

(57) ABSTRACT

A method determines an inadmissible deviation of a technical device using an artificial neural network which is supplied with input data and output data of the technical device in a learning phase. In a subsequent prediction phase, the neural network is only supplied with the input data, and comparative output data are calculated in the neural network and are compared to the output data of the technical device.

The invention relates to a method for determining an impermissible deviation of the system behavior of a technical device from a normal value range using an artificial neural network.

### PRIOR ART

DE 10 2018 206 805 B3 describes a method for predicting a driving maneuver of an object by means of two machine learning systems. The first machine learning system determines an output variable characterizing the object as a function of the first input variable, and the second machine learning system determines a second output variable, which characterizes a state of the object, as a function of a second input variable. The future movement of the object is predicted as a function of the output variables. The first machine learning system comprises a deep neural network and the second machine learning system a probabilistic graphical model.

Document DE 10 2018 209 916 A1 discloses a method for determining a sequence of output signals by means of a series of layers of a neural network based on input signals fed to an input layer of the neural network. At a defined time, new input signals are fed to the neural network while the previous input signals are still being propagated through the neural network.

### DISCLOSURE OF THE INVENTION

Using the method according to the invention, an impermissible deviation of the system behavior of a technical device from a standard value range can be determined. With this method it is possible to predict a complete or partial failure of the technical device before the actual failure occurs, so that appropriate countermeasures can be taken in good time. In this way, status monitoring of the technical device can be carried out with easily implemented measures. Deterioration of the system behavior as well as system anomalies can be detected in good time. By the specification and comparison with the standard value range it is possible to continuously monitor how the status of the technical device changes over time and to determine the time remaining for which the proper functioning of the technical device is guaranteed and the point beyond which the proper functioning can no longer be ensured, or at least no longer fully ensured.

The method for determining the impermissible deviation of the technical device uses an artificial neural network which is supplied with input data and output data of the technical device in a learning phase. By comparison with the input and output data of the technical device, the corresponding connections are created in the artificial neural network and the neural network is trained on the system behavior of the technical device.

In a prediction phase following the learning phase, the system behavior of the device can be reliably predicted in the neural network. For this purpose, in the prediction phase the neural network is only supplied with the input data of the technical device and output comparison data is calculated in the neural network, which is compared with output data of the technical device. If, as a result of this comparison, the difference between the output data of the technical device, which is preferably recorded as measured values, deviates too much from the output comparison data of the neural network and exceeds a limit value, an impermissible deviation of the system behavior of the technical device from the standard value range is present. Appropriate measures can then be taken, for example, to generate or store a warning signal or to deactivate partial functions of the technical device (degradation of the technical device). Where appropriate, alternative technical devices may be used as a fallback in the event of an impermissible deviation.

Using the method described above, a real technical device can be continuously monitored. In the learning phase, the neural network is supplied with a sufficient amount of information on the technical device, both from its input side and from its output side, so that the technical device can be represented and simulated in the neural network with sufficient accuracy. This allows both the technical device to be monitored and a deterioration of the system behavior to be predicted during the subsequent prediction phase. In this way, in particular, the remaining useful life of the technical device can be predicted.

According to an advantageous design, the neural network is divided into a base network and a head network, which together form the neural network. The base and head networks each consist of a plurality of layers, wherein the base and head networks interact, but they can be divided into sub-networks. Depending on the nature of the technical device, different types of layer can be used, in particular in the head network, for example, convolutional layers or dense layers.

It may be advantageous to provide a plurality of base networks which interact with a common head network. It is possible, for example, to use one base network for each highly dynamic measuring channel.

In the learning phase, both the base network and the head network are trained to the system behavior of a first technical device. This represents a first section of the learning phase. In a subsequent second section of the learning phase, the training takes place on a second technical device which is identical to the first technical device.

In this second section of the learning phase, only the head network is trained, but not the base network.

This design has the advantage that the head network can be trained on the specific system behavior of the second technical device, wherein the electronic device in which the neural network is implemented only needs to have a relatively low computing capacity. By contrast, the training in the first section of the learning phase using the first technical device can be carried out on another electronic device which has a higher computing capacity.

This sub-division of the learning phase into a first and a second section, as well as the training of both the base network and the head network in the first section of the learning phase and the training of only the head network in the second section of the learning phase, on the one hand satisfies strict requirements on the accuracy of the representation of the system behavior of the technical device in the neural network and, on the other hand, requirements on the ability of the neural network to run on an electronic device with limited computing capacity. In particular, it is possible to carry out the first section of the learning phase, which relates to the first technical device, centrally in a workshop or development environment or similar, whereas the second section of the learning phase is carried out in a decentralized form, for example in a vehicle. In this case, the second section of the learning phase is carried out, for example, on a control unit in the vehicle, for example on the control unit of an ESP (Electronic Stability Program) module.

In the prediction phase following the learning phase, according to a further advantageous design both the base network and the head network are used to determine an inadmissible deviation of the second technical device. The base network is trained from the first section of the learning phase to a technically identical device, the head network is also trained from the first section of the learning phase to a technically identical device, and in addition, trained from the second section of the learning phase to the specific second technical device. In the prediction phase, the base network and the head network interact to detect an impermissible deviation in the system behavior of the second technical device. The prediction phase requires a lower computing capacity than the learning phase, so that both sub-networks—the base network and the head network—can be operated in the prediction phase on an electronic device with reduced computing capacity.

According to a further advantageous design, the number of neurons in the head network is smaller than the number of neurons in the base network. For example, the difference can be at least a factor of five or at least a factor of ten. Even if the head network is at least ten times smaller, a sufficient adaptation to the system behavior of the second technical device is guaranteed in the second section of the learning phase.

The interaction between the base network and the head network takes place in such a way that in the learning and prediction phases the output of the base network is used as the input for the head network. In the prediction phase, the base network also receives the input data of the technical device which is being monitored by means of the neural network. In addition, the head network can also be supplied with measured values of the input data of the second technical device, in particular mean values of a relatively small number of dynamic measured values. The input data of the second technical device, which is fed to the base network as input, can also be measured values, in particular in a highly dynamic range, wherein this input is fed to the base network in the time or frequency domain.

Additional input information about the type or class of the input data can be fed to the head network. This can be, for example, information from a cluster analysis, preferably relating to the nature of a maneuver to be carried out in the second technical device. In the case of a technical device in a vehicle, in particular a braking system or a subsystem of a braking system, it may be, for example, the type of driving maneuver, such as a braking operation or maintaining distance in a traffic jam.

According to a further advantageous embodiment, the input data that is fed to the base network and, where appropriate, to the head network, can be subject to pre-processing. A first, advantageous pre-processing step to be performed is to divide the available measured values, or a subset of the available measured values, of the technical device, in particular the second technical device, which is being examined for impermissible deviation of the system behavior, into time segments of fixed length. In addition or alternatively, it is also possible to sub-divide the measured values or a subset thereof according to a known logic, for example, based on specific maneuvers. For technical devices that are only temporarily active, the subdivision can also be selected for each activation.

A further, advantageous pre-processing step provides that the measured values are subjected to a cluster analysis, for example using a k-means algorithm. In particular, this information concerning a particular class can be fed directly to the head network, which leads to an increase in the accuracy of the classification.

In accordance with a further advantageous pre-processing step, measured values, which are fed in particular to the base network and which are preferably highly dynamic measured values, are subjected to a Fourier transform, in particular a fast Fourier transform or a short-time Fourier transform (SIFT), in order to transform the input data from the time to the frequency domain. When using SIFT, it is possible to use mean values, maximum values, median values, or modal values per frequency range in order to reduce the volume of data. These options for the pre-processing step can also be applied to less dynamic input or measurement data.

If necessary, the data volume of the dynamic measured values can be reduced by reducing the sampling rate of the measured values.

The invention also relates to an electronic device, such as a control unit in a vehicle, equipped with means to carry out the method described above. These means are in particular at least one computing unit and at least one storage unit for carrying out the necessary calculations or for storing the input and output data.

The invention also relates to a computer program product having a program code which is designed to execute the above-mentioned method steps. The computer program product can be stored on a machine-readable storage medium and can run in an above-mentioned electronic device.

The method can be applied, for example, to monitoring the status of a technical system in a vehicle, such as a steering system or a braking system. In this case, the electronic device is advantageously a control unit that can be used to control the components of the technical device. Furthermore, it is also possible to monitor only one subsystem within a larger system as the technical device, for example an ESP module (Electronic Stability Program) in a braking system.

Further advantages and expedient designs can be derived from the other claims, the description of the figures and the drawings. In the drawings:

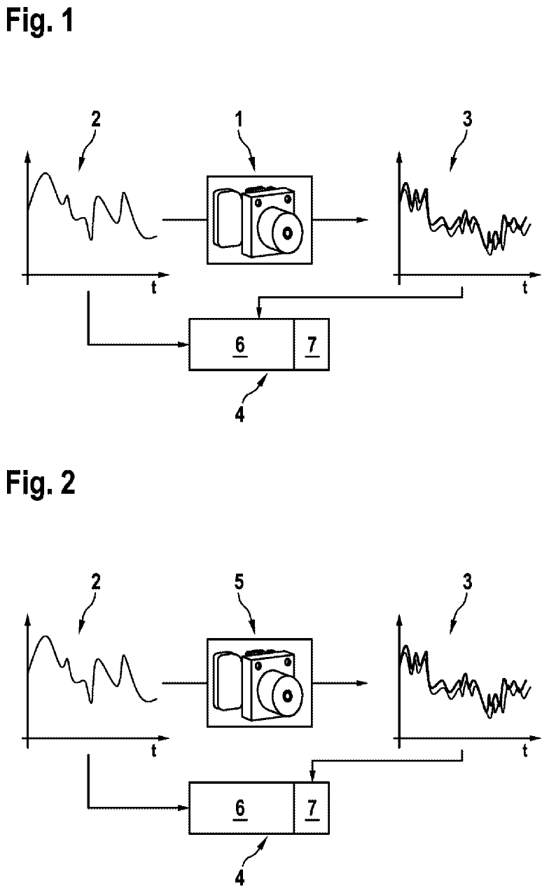

FIG. 1 shows a block diagram with a symbolic illustration of a first ESP module to which input data is fed and which produces output data, with a parallel connected neural network consisting of a base network and a head network, which is in the first section of a learning phase,

FIG. 2 shows the block diagram according to FIG. 1, but with a second ESP module and the neural network in a second section of the learning phase,

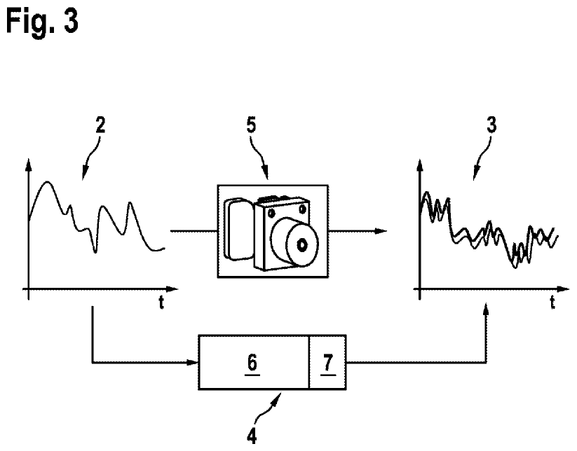

FIG. 3 shows the block diagram according to FIG. 2 with the second ESP module and the neural network in a prediction phase,

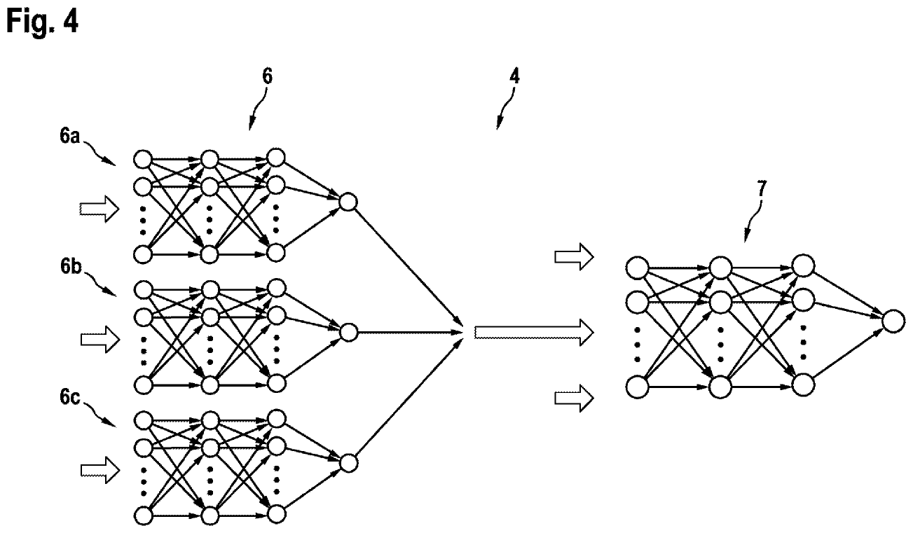

FIG. 4 shows the base network and the head network of the neural network in a detailed representation.

In the figures, equivalent components are labelled with the same reference signs.

The block diagram according to FIG. 1 shows a schematic diagram of a technical device 1 in the form of an ESP module for a braking system in a vehicle with input and output data and with a parallel connected neural network 4. The ESP module 1, which by way of example is used as the technical device, comprises an ESP pump for generating a desired, modulated brake pressure in the braking system, and a control unit for controlling the ESP pump. The ESP module 1 is supplied with input data 2, for example an input current for the electrically operated ESP pump of the ESP module 1, wherein in response to the input data 2 the ESP module 1 produces output data 3, for example a hydraulic brake pressure.

Connected in parallel with the technical device 1 is a neural network 4, which is trained in a learning phase to the system behavior of the technical device 1, for which the input data 2 and the output data 3 of the technical device 1 are fed to the neural network 4 during the learning phase.

The neural network 4 is divided into a base network and a head network, which each have a plurality of layers and interact. The output of the base network 6 represents the input of the head network 7. The base network 6 is significantly larger than the head network 7; the number of neurons of the base network is preferably at least a factor of five or at least a factor of ten greater than the number of neurons of the head network 7.

FIG. 1 shows a first section of the learning phase, in which both the base network 6 and the head network 7 are trained on the system behavior of the technical device 1. For this purpose, both the input data 2 and the output data of the technical device 1 are fed to the base network 6 as input and connections are created in the base network 6 and the head network 7.

The first section of the learning phase according to FIG. 1 can be carried out during a development phase of the technical device 1. After the completion of the first section of the learning phase, the training for the base network 6 is terminated.

FIG. 2 shows a second section of the learning phase for the neural network 4, wherein this second section of the learning phase is carried out on a second technical device 5, which is technically identical to the first technical device 1. This second section of the learning phase relates only to the head network 7 of the neural network 4, while the base network 6 is no longer trained in the second section of the learning phase. Due to the lesser computational effort involved, this design enables the second section of the learning phase to be carried out on a correspondingly less powerful control unit, in particular directly at the installation site of the second technical device 5. In the case of an ESP module 5, the second section of the learning phase can be carried out in the control unit of the ESP module.

Also in the second section of the learning phase, the input data 2 and the output data 3 of the second technical device 5 are fed to the neural network 4 as input, but exclusively to the head network 7 of the neural network.

FIG. 3 shows the second technical device 5 in a prediction phase of the neural network 4. The learning phase has been completed, the head network 7 has been sufficiently trained for the specific application with the second technical device 5. In the prediction phase according to FIG. 3, the neural network 4 is supplied with the input data 2 of the second technical device 5 as input, wherein in the neural network with the base network 6 and the head network 7, on the basis of the learned behavior, output reference data are generated which are compared with the output data 3 of the second technical device 5. If the deviation is so great that the output data 3 of the technical device 5 is outside a given standard value range, an impermissibly large deterioration of the system behavior of the technical device 5 exists, from which a shortened service life or an imminent partial failure or complete failure of the technical device 5 can be concluded. Measures can then be taken, such as the generation of a warning signal, or a reduction in the functional scope of the technical device 5.

FIG. 4 shows the detailed structure of the neural network with the base network 6 and the head network 7. The base network 6 comprises a plurality of individual base networks or sub-base networks 6a, 6b and 6c, to which measured values in the time or frequency domain of a highly dynamic measuring channel are fed as input data. In the learning phase, these are input and output data of the technical device and in the prediction phase, input data of the technical device.

On the output side, the generated data in the sub-base networks 6a, 6b and 6c are fed to the head network 7 as input, in which further connections are created in the learning phase and a prediction is made about the system behavior of the technical device under consideration in the prediction phase. In the second section of the learning phase, the output data of the second technical device can be fed directly to the head network 7 as input, as can also be seen in FIG. 2.

In the prediction phase, supplementary information can be fed to the head network 7 as additional input, for example information about the type or class of the input data, or static measured values or mean values of low-dynamic measured values.

1. A method for determining an impermissible deviation of a system behavior of a technical device from a normal value range using an artificial neural network comprising:
supplying the neural network with input data and output data of the technical device in a learning phase;
in a prediction phase following the learning phase (i) feeding only the input data of the technical device to the neural network, and (ii) calculating output reference data in the neural network; and
identifying the impermissible deviation when the output data of the technical device is outside the normal value range based on a difference with respect to the output reference data calculated by the neural network.

2. The method as claimed in claim 1, wherein:
the neural network is divided into a base network and a head network,
in a first section of the learning phase both the base network and the head network are trained on a first technical device, and
in a second section of the learning phase only the head network is trained on a second technical device which is identical to the first technical device.

3. The method as claimed in claim 2, wherein in the prediction phase both the base network and the head network are used to determine an inadmissible deviation of the second technical device.

4. The method as claimed in claim 2, wherein a number of neurons of the head network is smaller than a number of neurons of the base network by at least a factor of five or ten.

5. The method as claimed in claim 2, wherein an output of the base network is used as an input for the head network.

6. The method as claimed in claim 2, wherein measured values of the second technical device are fed to the head network as an input.

7. The method as claimed in claim 2, wherein information about a type or a class of the input data is fed to the head network as an input.

8. The method as claimed in claim 2, wherein the neural network comprises a plurality of the base networks to which different input data are fed.

9. The method as claimed in claim 8, wherein an output of each of the base networks is fed to a common head network.

10. The method as claimed in claim 2, wherein the input data is subjected to pre-processing before the calculating takes place in the neural network.

11. The method as claimed in claim 1, wherein a control unit in a vehicle is configured to carry out the method.

12. The method as claimed in claim 1, wherein a computer program product includes program code configured to carry out the method.

13. The method as claimed in claim 12, wherein a non-transitory machine-readable storage medium is configured to store the computer program product.
